(19) United States
(12) Patent Application Publication
(10) Pub. No.: US 2005/0015580 A1
(43) Pub. Date: Jan. 20, 2005

(54) METHOD FOR TRANSFERRING A COMMAND AMONG A PLURALITY OF DEVICES IN A COMPUTER SYSTEM

(76) Inventors: Yi-Chang Chen, Taipei Hsien (TW); Chih-Hsuan Wu, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,329

(22) Filed: Sep. 23, 2003

(30) Foreign Application Priority Data
Jul. 14, 2003 (TW) 092119175

(51) Int. Cl. G06F 9/44

(52) U.S. Cl. 713/2

(57) ABSTRACT

A method is used for transferring a command among a plurality of devices in a computer system to operate the computer system. The plurality of devices at least include a first storage device and a second storage device, and the first storage device is used to store a first code. The method includes: (a) executing the first code in the first storage device; (b) after step (a), executing an examining process before the first storage device transfers the command to the second storage device; (c) after step (b), if the result of the examining process is correct, the first storage device transfers the command to the second storage device to operate the computer system; and (d) after step (b), if the result of the examining process is incorrect, the first storage device does not transfer the command to the second storage device.

### BACKGROUND OF INVENTION

1. Field of the Invention

The invention relates to a method for transferring a command among a plurality of devices of a computer system, and more particularly, to a method for executing an examining process before the command is transferred to make sure the command is being correctly transferred and to quickly reboot the computer system.

2. Description of the Prior Art

With the rapid development of information technology, computer systems play important roles in modernizing many companies and are widely used in practically every industry. Consequently, the manufacturing of portable computers, including PDAs and notebooks, has become a mainstream business in the computer industry. In order to utilize the portable computer systems without an external power supply, users require batteries to provide sufficient power to the computer system. However, the power stored in the battery is exhaustible, so users usually turn off the portable computer systems when they do not use the portable computer systems, and the portable computer systems will be rebooted after the users arrive at a certain place and begin to work. However, since the graphical operating systems develop quickly, the more powerful operating systems become, the longer the portable computer systems take to load the related operating systems. That is, the reboot process becomes very complicated and time-consuming. It is very inconvenient for computer users to wait for a long time in the reboot process just in order to check a calendar or memorandum data.

For improving the above-mentioned lack of efficiency in the reboot process, we have to clarify how the computer system operates in the booting process. Currently, in the booting process, most computer systems utilize a basic input/output system (BIOS) program that is stored in a non-volatile memory, and which is first executed by a central processing unit (CPU) when the computer system is turned on. Besides providing key low-level support for device drivers and operating systems, the BIOS program contains a power on self-test (POST) program, and a bootstrap program. The POST program ensures that the basic components of the computer system are operating correctly. After a successful completion of the POST program, the BIOS program executes the bootstrap program, the purpose of which is to load boot code into memory to boot an operating system.

In addition, regarding the notebook or PC system, a prior-art STR (suspend to RAM) feature has been applied for the computer entering into a standby mode from an operating mode. After being relieved from the standby mode (an STR status), the computer can quickly resume operation (back to the operating mode). It takes only 5 seconds from holding to recovering (from the standby mode to the operating mode). Please refer to FIG. 1. FIG. 1 is a functional block diagram of a (portable) computer system 10 according to the prior art. The computer system 10 includes a processor 12, a non-volatile storage device 14, a volatile storage device 16, and a periphery device module 18. The non-volatile storage device 14 is used to store the BIOS of the computer system 10, and the processor 12 is used to control operations of the computer system 10. In addition, the processor 12 can exchange instructions and signals with the non-volatile storage device 14, the volatile storage device 16, a display processing module 34, and the periphery device module 18 so as to fully operate the computer system 10.

When the computer system 10 operates, the computer system 10 will load the related codes, including the operating system, the programming codes, and part of the BIOS into the volatile storage device 16, so that the processor 12 can execute those codes to operate the computer system 10. When users utilize the prior-art STR function, users can press at least a predetermined button of the computer system 10 to switch the computer system 10 from the operating mode to the standby mode. After users press the predetermined button, the processor 12 will confirm that the computer system 10 is about to enter into the standby mode according to a basic code of the BIOS. Since the volatile storage device 16 stores the codes including a condition describing how the computer system 10 operates before the standby mode, the computer system 10 stops providing power to the processor 12 and the periphery device module 18 and provides power only to the volatile storage device 16 so that the volatile storage device 16 can maintain the codes. When the computer system 10 is in the standby mode, the processor 12 and the periphery device module 18 stop operating and consume little power. In the standby mode, due to that the operations of the processor 12, the periphery device module 18, and most devices and circuits of the computer system 10 are terminated, the power demands for the computer system 10 will be largely reduced, which is the objective of the STR function (the standby mode).

Corresponding to the above-mentioned operation directing the computer to enter into the standby mode, the computer system 10 must include at least a related function for waking up the computer system 10 (a plurality of codes or signals related to wake-up events can be stored in the BIOS in the non-volatile storage device 14). Generally, the action of pushing any button of the computer system 10 or touching a turn-on key matches a wake-up event directing the computer system 10 from the standby mode to the operating mode. When the computer system 10 is about to be switched from the standby mode to the operating mode, the computer system 10 will execute the BIOS stored in the non-volatile storage device 14 to leave the standby mode. At this moment, the command controlling the computer system 10 is located in the non-volatile storage device 14. After part of the BIOS stored in the non-volatile storage device 14 is executed, the execution step will jump to the volatile storage device 16 so that the codes (the BIOS or the operating system) stored in the volatile storage device 16 will continue to achieve the mode-transformation process (from the standby mode to the operating mode). At this moment, the command (mainly controlling the computer system 10) is transferred from the non-volatile storage device 14 to the volatile storage device 16. In the standby mode, the volatile storage device 16 can maintain the stored codes (due to that power still supplies the volatile storage device 16 in the standby mode), and the stored codes of the volatile storage device 16 include a condition describing how the computer system 10 operates before entering in the standby mode. Therefore, once the computer system 10 is relieved from the standby mode, the processor 12 can directly execute the BIOS or the operating system in the volatile storage device 16 and quickly continue the operations of the computer system 10.

Therefore, the command transferring process plays an important role when the computer system operates, especially during the boot/reboot process. The result of the command transferring process determines whether the computer system can normally and smoothly operate or not. Please continue to refer to FIG. 1. When the BIOS or the operating system in the volatile storage device 16 is incorrect, non-intact, or even non-existent, the operation may fail and the computer system 10 may even crash after the command is transferred from the non-volatile storage device 14 to the volatile storage device 16. For illustrating importance of the command transferring process when the computer system operates, please refer to FIG. 2, which is a functional block diagram of an embodiment showing operations of partial devices shown in FIG. 1. The present embodiment shown in FIG. 2 includes the processor 12 and the periphery device module 18. The periphery device module 18 includes a display device 20, and the display device 20 corresponds to an application code, which may be stored in a BIOS of the display device 20. When the processor 12 is utilized to operate the display device 20, the command should be transferred to the BIOS of the display device 20 to execute the application code. After the application code is partially or fully executed, the display device 20 then returns the command back to the processor 12. Similar to the embodiment shown in FIG. 1, if the BIOS or the application code (in the display device 20) is incorrect, non-intact, or even non-existent, the command transferring process may fail and the computer system 10 may even crash due to that there is no corresponding examining process to predictably ensure the accuracy of the command transferring process.

### SUMMARY OF INVENTION

It is therefore a primary objective of the claimed invention to provide a method for transferring a command among a plurality of devices of a computer system to ensure the accuracy of a command transferring process and to solve the above-mentioned problems.

According to the claimed invention, a method for transferring a command among a plurality of devices of a computer system to operate the computer system is disclosed. The plurality of devices at least include a first storage device and a second storage device, and the first storage device is used for storing a first code. The method includes (a) executing the first code in the first storage device; (b) after proceeding with step (a), executing an examining process before the first storage device transfers the command to the second storage device; (c) after proceeding with step (b), the first storage device transferring the command to the second storage device to operate the computer system when a result of the examining process is correct; and (d) after proceeding with step (b), the first storage device not transferring the command to the second storage device when the result of the examining process is incorrect.

According to the claimed invention, a method for switching a computer system from a standby mode to an operating mode is disclosed. The computer system includes a first storage device for storing a basic input output system (BIOS) of the computer system, and a second storage device for temporarily storing data. The method includes: (a) utilizing the second storage device to store a condition before the computer system enters the standby mode; (b) executing the BIOS in the first storage device to cease the standby mode; (c) after proceeding with step (b), executing an examining process; and (d) after proceeding with step (c), switching the computer system into the operating mode according to the condition stored in the second storage device when the result of the examining process is correct.

According to the claimed invention, a method for transferring a command among plurality of devices in a computer system includes (a) executing an examining process when transferring the command; (b) in step (a), achieving the transfer of the command when a result of the examining process is correct; and (c) in step (a), failing the transfer of the command when the result of the examining process is incorrect.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a computer system according to the prior art.

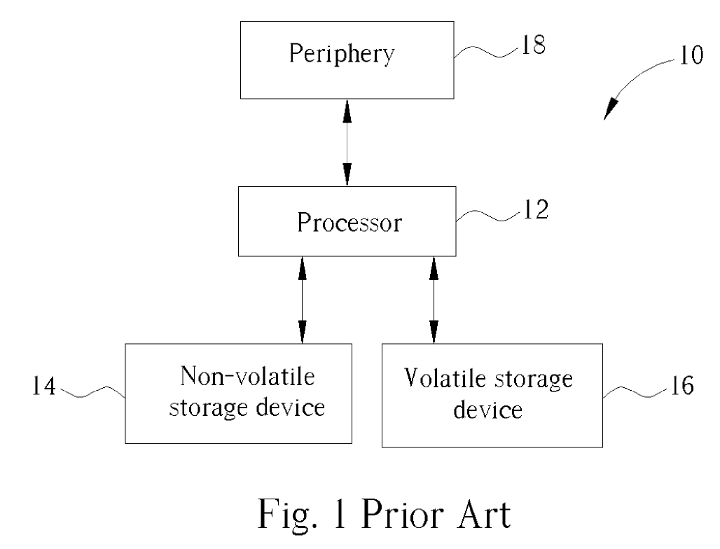

FIG. 2 is a functional block diagram of an embodiment showing operations of partial devices shown in FIG. 1.

FIG. 3 is a functional block diagram of a computer system according to the present invention.

FIG. 4 is a flow chart of an embodiment of the present invention.

FIG. 5 is a functional block diagram of an embodiment that inherits the structure of the computer system shown in FIG. 3.

FIG. 6 is a flow chart of another detailed method embodiment.

FIG. 7 is a functional block diagram of another embodiment related to FIG. 2.

FIG. 8 is a flow chart showing the method for transferring a command among a plurality of devices of the computer system.

### DETAILED DESCRIPTION

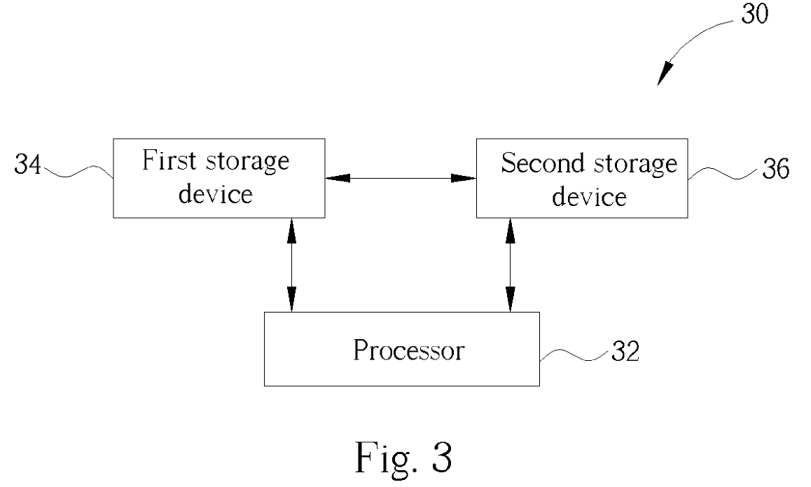

One of the main characteristics of the present invention is an examining process executed before a computer system is switched from a standby mode to an operating mode so that the computer system can correctly achieve the mode transformation to be quickly rebooted. The related hardware structure is shown in FIG. 3, which is a functional block diagram of a computer system according to the present invention. The computer system 30 can be a notebook computer, a personal computer system (PC), an information appliance, or a PDA. The computer system 30 includes a first storage device 34 and a second storage device 36. The first storage device 34 can be a non-volatile read-only storage device (ROM), which is used to store the BIOS of the computer system 30, and the second storage device 36 can be a volatile random access storage device (RAM), which is used to temporarily store a code. The stored code can be the BIOS, an operating system, or other programming code. The computer system 30 further includes a processor 32 used to control operations of the computer system 30. When the computer system 30 is in the operating mode, the computer system 30 will load necessary codes, including the operating system, programming codes, or even part of the BIOS, into the second storage device 36, so that the processor 32 can execute these codes to operate the computer system 30.

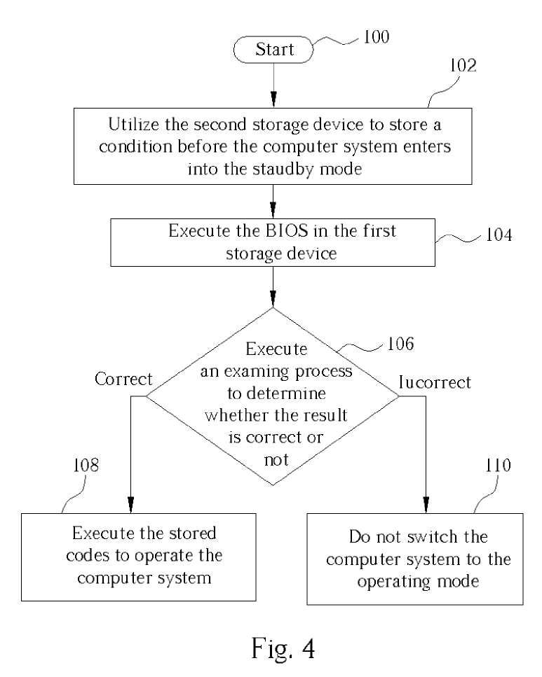

When the computer system 30 is about to be switched to the standby mode, the second storage device 36 stores codes including a condition describing how the computer system 30 operates before entering into the standby mode. After the computer system 10 enters into the standby mode, the computer system 10 stops providing power for the processor 32 and other circuitries except the second storage device 36 so that the second storage device 36 can maintain the stored codes. Therefore, due to that the processor 32 and most of the circuitries in the computer system 30 are terminated in the standby mode, the computer system 30 consumes much less power in the standby mode than does the computer system 30 in the operating mode. Afterwards, if users want to switch the computer system 30 from the standby mode back to the operating mode, the BIOS in the first storage device 34 will be executed to terminate the standby mode and an examining process will be immediately executed. The examining process will be detailed in following paragraphs. Please notice that only when the result of the examining process is correct, the computer system 30 can be switched to the operating mode according to the codes (the condition of the computer system 30) stored in the second storage device 36. On the other hand, when the result of the examining process is incorrect, a re-boot process or a debug process will be executed to avoid executing the incorrect or non-intact codes in the second storage device 36. An embodiment showing a method according to the present invention can refer to FIG. 4, which is a flow chart of an embodiment of the present invention with following steps:
Step 100: Start;
Step 102: utilize the second storage device 36 to store a condition describing how the computer system 30 operates before entering into the standby mode;
Step 104: execute the BIOS in the first storage device 34 so as to terminate the standby mode;
Step 106: execute the examining process; if the result of the examining process is correct, proceed with step 108; if the result of the examining process is incorrect, proceed with step 110;
Step 108: execute the stored codes (the BIOS or the operating system) in the second storage device 36 according to the condition of the computer system 30 stored in the second storage device 36, and then switch the computer system 30 to the operating mode to operate the computer system 30;
Step 110: do not switch the computer system 30 to the operating mode, and execute the re-boot process or debug process.

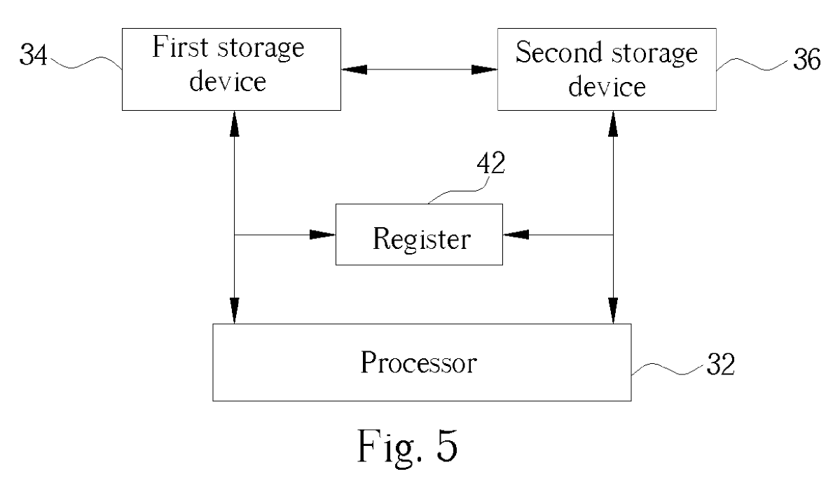

As the method described in Step 102, when the computer system 30 executes the BIOS in the first storage device 34 to terminate the standby mode, the command controlling the computer system 30 is located in the first storage device 34. When a specific instruction of the BIOS in the first storage device 34 is executed, an execution step will jump to the second storage device 36 so that the stored codes (BIOS or the operating system) in the second storage device 36 can be utilized to continue finishing the mode transformation. When the execution step will jump to the second storage device 36, the command is transferred from the first storage device 34 to the second storage device 36. Please refer to FIG. 5, which is a functional block diagram of an embodiment that inherits the structure of the computer system 30 shown in FIG. 3. Please notice that another register 42 is installed in the present embodiment shown in FIG. 5. Due to that the content of the codes (BIOS or the operating system) in the second storage device 36 are previously available for users, users can determine whether the result of the examining process is correct or incorrect by examining whether a predetermined instruction of the codes conforms to a predetermined condition or not according to the content of the codes before the command is transferred from the first storage device 34 to the second storage device 36. For instance, a first instruction stored in the second storage device 36, such as “S3_First_Com”, can be loaded into the register 42 shown in FIG. 5 to compare if the loaded first instruction (S3_First_Com) matches a predetermined instruction. The loading and comparing processes can be implemented by software or hardware of the computer system 30. Therefore, if the loaded first instruction matches the predetermined instruction (both are “S3_First_Com”), the result of the examining process is correct. On the other hand, if the result of the examining process is incorrect, and the computer system 30 has to be debugged or rebooted.

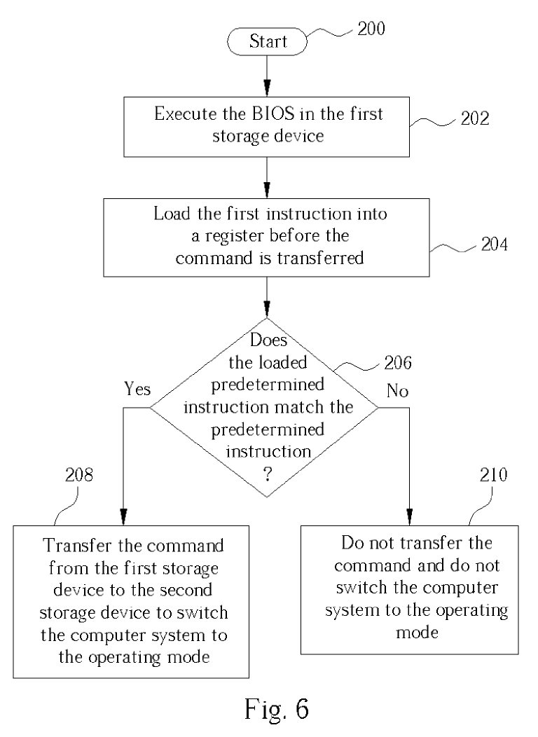

Based on the embodiment shown in FIG. 5, FIG. 6 shows a detailed method embodiment by comparing the first instruction stored in the second storage device 36 with a predetermined instruction to operate the computer system 30. Please refer to FIG. 6, which is a flow chart of another detailed method embodiment, which includes following step:

Step 200: start;
Step 202: execute the BIOS in the first storage device 34;
Step 204: load the first instruction of the codes stored in the second storage device 36 into a register 42 before the command is transferred from the first storage device 34 to the second storage device 36;
Step 206: check whether the loaded predetermined instruction matches the predetermined instruction or not; if the loaded first instruction matches the predetermined instruction, proceed with Step 208; if the loaded first instruction does not match the predetermined instruction, proceed with Step 210;
Step 208: transfer the command from the first storage device 34 to the second storage device 36, and execute the stored code (BIOS or the operating system) in the second storage device 36 so as to switch the computer system 30 to the operating mode;
Step 210: do not transfer the command from the first storage device 34 to the second storage device 36, and do not switch the computer system 30 to the operating mode; afterwards, execute a re-boot process or a debug process.

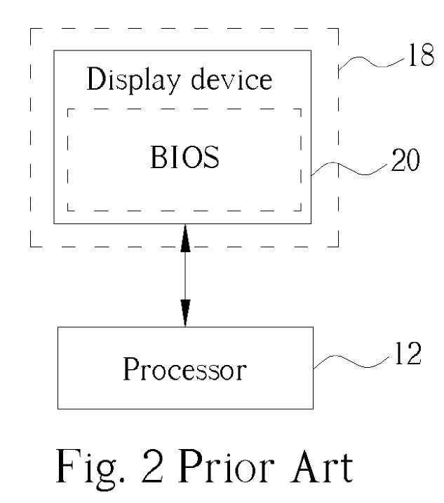

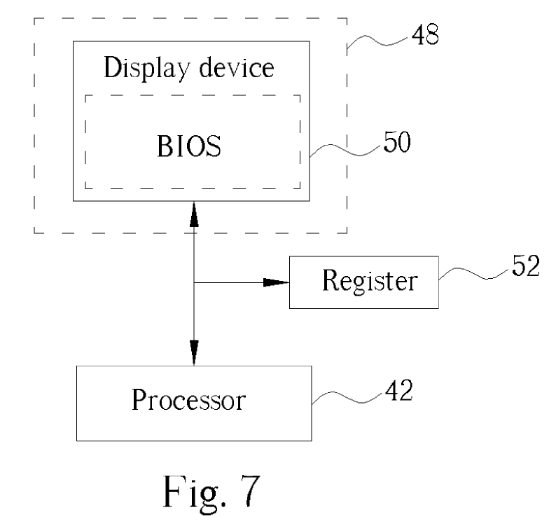

The characteristics of the present invention are not constrained in the mode transformation of the computer system 30. In fact, the method of the present invention can be applied to various conditions whenever a command is transferred among a plurality of devices in the computer system 30. The characteristic of the present invention is to execute an examining process before the command is transferred so as to ensure that the command is transferred correctly. Please refer to FIG. 7, which is a functional block diagram of another embodiment related to FIG. 2. The present embodiment inherits the structure shown in FIG. 2 with an additional installation of a register 52. The present embodiment includes a processor 42 and a periphery device module 48. The periphery device module 48 is a display device 50. The display device 50 still includes corresponding BIOS of the display device and an application code with given content. Before the processor 42 actuates the display device 50 and transfers the command to the BIOS of the display device 50, an examining process can be executed according to a predetermined instruction or a predetermined tag in the present invention. According to the former statements in the previous embodiments, the predetermined tag, which can be a tag initially contained in the application code or later added by users, can be utilized for examination in a manner similar to that of the predetermined instruction; that is, users or program designers can utilize the application code to load the predetermined tag in the given content of the application code in the display device 50 (such as INT10_SYMBOL) into the register 52 shown in FIG. 7 before the command is transferred to the display device 50, and determines whether the loaded predetermined tag (INT10_SYMBOL) is equal to a default tag (The comparison function can be implemented by software or hardware). Therefore, when the loaded predetermined tag matches the default tag, the result of the examining process is correct and the command can be transferred. On the other hand, the result of the examining process is incorrect, and the computer system 30 requires being debugged or rebooted.

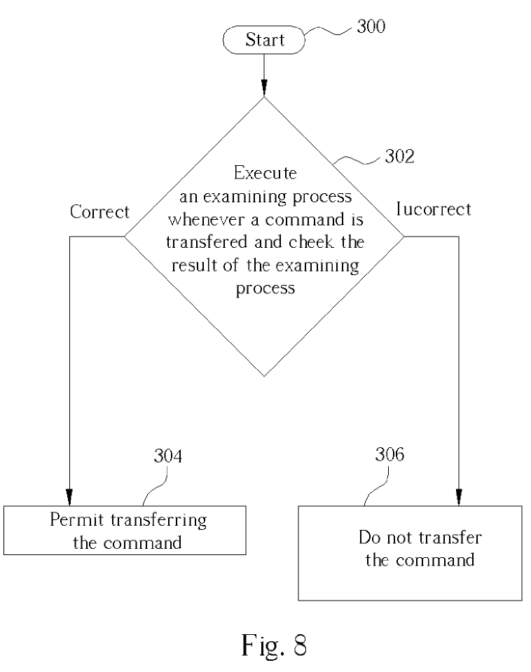

In summary, a method embodiment including all characteristics of the present invention can refer to FIG. 8, which is a flow chart showing the method for transferring a command among a plurality of devices of the computer system 30. Each device corresponds to an application code.
Step 300: start;
Step 302: execute an examining process when a command is transferred so as to examine whether an application code of a device that is about to receive the command is correct or not. For instance, a predetermined instruction or a predetermined tag contained in the application code can be used to determine if the predetermined instruction or the predetermined tag conforms to a predetermined condition to determine the correction of the application code. If the predetermined instruction or the predetermined tag conforms to the predetermined condition, the result of the examining process is correct with correct application code, and Step 304 is executed; otherwise, proceed with Step 306;
Step 304: Permit transferring the command;
Step 306: Do not transfer the command and proceed with a debug or a re-boot operation.

The present invention can be applied to a computer system whenever a command is transferred among a plurality of devices in the computer system. The characteristic of the present invention is to execute an examining process before the command is transferred so as to ensure that the command is transferred correctly and to avoid any abnormal operation of the computer system. When the characteristic of the present invention is applied to the boot/reboot process and the mode transformation of the computer system, the computer system can be quickly and correctly relieved from the standby mode.

Those skilled in the art will readily observe that numerous modifications and alterations of the device and method may be made while retaining the teachings of the invention. Accordingly, the above disclosure should be construed as limited only by the metes and bounds of the appended claims.

1. A method for transferring a command among a plurality of devices of a computer system to operate the computer system, the plurality of devices at least comprising a first storage device and a second storage device, the first storage device used for storing a first code, the method comprising:
(a) executing the first code in the first storage device;
(b) after proceeding with step (a), executing an examining process before the first storage device transfers the command to the second storage device;
(c) after proceeding with step (b), the first storage device transferring the command to the second storage device to operate the computer system when a result of the examining process is correct; and
(d) after proceeding with step (b), the first storage device not transferring the command to the second storage device when the result of the examining process is incorrect.

2. The method of claim 1 wherein the second storage device stores a second code, the method further comprising:
(e) in step (b), examining whether a predetermined instruction of the second code conforms to a predetermined condition to determine whether the result of the examining process is correct or incorrect; and
(f) in step (c), executing the second code in the second storage device to operate the computer system after the first storage device transfers the command to the second storage device.

3. The method of claim 2 wherein the computer system further comprises a register, the method further comprising:
(g) in step (e), recording the predetermined instruction of the second code into the register and then checking whether the predetermined instruction conforms to the predetermined condition to determine whether the result of the examining process is correct or incorrect.

4. The method of claim 2 wherein the predetermined instruction is a first instruction of the second code.

5. The method of claim 1 further comprising:
(h) in step (b), executing the examining process when a predetermined site of the first code is executed; and
(i) in step (d), executing a re-boot process or a debug process when the result of the examining process is incorrect.

6. The method of claim 1 wherein the first storage device is a read-only storage device (ROM), and the first code is a basic input output system (BIOS) of the computer system.

7. The method of claim 1 wherein the second storage device is a random access storage device (RAM), and the second code is a basic input output system or an operating system of the computer system.

8. The method of claim 1 wherein the computer system is a notebook computer, a personal computer system (PC), an information appliance, or a personal digital assistant (PDA).

9. A method for switching a computer system from a standby mode to an operating mode, the computer system comprising:
a first storage device for storing a basic input output system (BIOS) of the computer system;
a second storage device for temporarily storing data;
the method comprising:
(a) utilizing the second storage device to store a condition before the computer system enters the standby mode;
(b) executing the BIOS in the first storage device to cease the standby mode;
(c) after proceeding with step (b), executing an examining process; and
(d) after proceeding with step (c), switching the computer system into the operating mode according to the condition stored in the second storage device when the result of the examining process is correct.

10. The method of claim 9 further comprising:
(e) after proceeding with step (c), executing a re-boot process or a debug process when the result of the examining process is incorrect.

11. The method of claim 9 wherein the computer system consumes less power in the standby mode than the computer system does in the operating mode.

12. The method of claim 9 wherein the second storage device stores an application code, the application code corresponding to a condition before the computer system enters the standby mode, the method further comprising:
(f) in step (c), examining whether a predetermined instruction of the application code conforms to a predetermined condition to determine whether the result of the examining process is correct or incorrect; and
(g) in step (d), executing the application code in the second storage device to switch the computer system into the operating mode.

13. The method of claim 12 wherein the computer system further comprises a register, the method further comprising:
(h) in step (f), recording the predetermined instruction of the application code into the register and then checking whether the predetermined instruction conforms to the predetermined condition to determine whether the result of the examining process is correct or incorrect.

14. The method of claim 12 wherein the predetermined instruction is a first instruction of the application code.

15. The method of claim 9 wherein the first storage device is a non-volatile read-only storage device.

16. The method of claim 9 wherein the second storage device is a volatile random access storage device.

17. The method of claim 9 wherein the computer system is a notebook computer, a personal computer system (PC), an information appliance, or a personal digital assistant (PDA).

18. A method for transferring a command among plurality of devices in a computer system, the method comprising:
(a) executing an examining process when transferring the command;
(b) in step (a), achieving the transfer of the command when a result of the examining process is correct; and
(c) in step (a), failing the transfer of the command when the result of the examining process is incorrect.

19. The method of claim 18 wherein each device corresponds to an application code, the method further comprising:
(d) in step (a), when transferring the command, examining whether the application code corresponding to the device that is about to receive the command is correct or not; if the application code is correct, the result of the examining process is correct; if the application code is incorrect, the result of the examining process is incorrect.

20. The method of claim 19 wherein each application code comprises a predetermined instruction or a predetermined tag, the examining process determines whether the application code is correct according to whether the predetermined instruction or the predetermined tag of the application code conforms to a predetermined condition.

21. The method of claim 19 wherein each application code corresponds to a basic input/output system (BIOS).

22. The method of claim 18 wherein the computer system is a notebook computer, a personal computer system (PC), an information appliance, or a personal digital assistant (PDA).
